(19) United States
(12) Patent Application Publication
(10) Pub. No.: US 2015/0264774 A1
(43) Pub. Date: Sep. 17, 2015

(54) OLED Lighting Apparatus

(71) Applicants: Toshiba Lighting & Technology Corporation, Yokosuka-shi (JP); Kabushiki Kaisha Toshiba, Tokyo (JP)

(72) Inventors: Takashi Kaneko, Yokosuka-shi (JP); Junya Hayashi, Yokosuka-shi (JP)

(73) Assignees: Toshiba Lighting & Technology Corporation, Yokosuka-shi (JP); Kabushiki Kaisha Toshiba, Tokyo (JP)

(21) Appl. No.: 14/477,943

(22) Filed: Sep. 5, 2014

(30) Foreign Application Priority Data
Mar. 14, 2014 (JP) 2014-051802

(51) Int. Cl. H05B 33/08; H05B 37/02

(52) U.S. Cl. CPC H05B 33/0896; H05B 37/0218; H05B 37/0227

(57) ABSTRACT

An OLED lighting apparatus according to an embodiment includes an OLED panel, an illuminance sensor, and a control device. The OLED panel transmits light when the light is OFF and performs irradiation of light from one surface side of an irradiation surface when the light is ON. The illuminance sensor detects an environmental condition on the other surface side of the irradiation surface of the OLED panel. The control device controls a lighting state of the OLED panel which is ON in response to the environmental condition detected by the illuminance sensor. The control device also switches the lighting state of the OLED panel between ON and OFF.

### CROSS-REFERENCE TO RELATED APPLICATIONS

This application is based upon and claims the benefit of priorities from Japanese Patent Application No. 2014-051802 filed on Mar. 14, 2014; the entire contents of which are incorporated herein by reference.

### FIELD

Embodiments described herein relate generally to an OLED lighting apparatus.

### BACKGROUND

Recently, an organic light-emitting diode (OLED) utilizing organic electroluminescence is used as a light source for a lighting device. In an OLED panel using the OLED, a light emission layer is arranged between an anode and a cathode. Positive holes are injected from the anode and electrons are injected from the cathode to be recoupled in the light emission layer, thereby emitting light on account of energy generated at that time.

In order to manufacture a general OLED panel, a transparent electrode is arranged on a glass substrate as the anode, a transportation layer and a light emission layer are sequentially deposited, and after a cathode is further deposited, sealing is performed with a glass sealing cap. Generally, the cathode of an OLED panel is formed using Al or Ag. However, recently, a double-sided light emitting structure in which a transparent electrode such as an indium in oxide (ITO) electrode that is a transparent conductive film is used as the cathode, and a single-sided light emitting structure in which the cathode is micro-wired so as to be transparent when the light is OFF while emitting light from only one side when the light is ON are being developed.

Installations such as an escalator and an elevator are often installed inside facilities which are available for an indefinite large number of people. Therefore, when a lighting device is adopted to illuminate the facilities or a transparent member is used as a partition member that divides the inside and the outside of the facilities in order to improve the appearance thereof, users of the escalator are exposed to public gaze.

Street lamps as lighting devices are installed on roads to ensure visibility at night. Generally, street lamps are installed at predetermined intervals. Therefore, there are many places on the road in which visibility is not favorable at night. In such places, it is difficult to recognize a pedestrian walking on a sidewalk from a roadway side. Particularly, on roads where the roadway and the sidewalk are divided by a partition member such as a guardrail, the partition member is illuminated with light from a headlamp of a vehicle traveling on the roadway, and a pedestrian walking on the sidewalk is surrounded by relative darkness, thereby often being difficult to be recognized from a vehicle. Generally, the partition member is adopted to partition a space. However, depending on the purpose of use thereof, there is room for improvement regarding the protection of privacy or the recognition of the presence of people.

Exemplary embodiments herein are made in consideration of the above description and aims to provide an OLED lighting apparatus that can be compatible with both ensuring the aesthetic beauty of the landscape and protecting the privacy, and can notify the driver of a vehicle of the presence of people.

### BRIEF DESCRIPTION OF THE DRAWINGS

FIG. 1 is a schematic diagram of an escalator in which an OLED lighting apparatus of Embodiment 1 is used.

FIG. 2 is a detailed cross-sectional view of an OLED panel.

FIG. 3 is a cross-sectional view taken along line III-III in FIG. 2.

FIG. 4 is a diagram illustrating the OLED panel when the light is OFF.

FIG. 5 is a diagram illustrating the OLED panel when the light is ON.

FIG. 6 is a diagram illustrating a guardrail in which the OLED lighting apparatus of Embodiment 2 is used.

FIG. 7 is a view illustrating the guardrail when seen from a sidewalk side.

FIG. 8 is a perspective view of a table in which the OLED lighting apparatus of Embodiment 3 is used.

FIG. 9 is a cross-sectional view taken along line IX-IX in FIG. 8.

FIG. 10 is an arrow view of line X-X in FIG. 9.

FIG. 11 is a view illustrating an aspect of the table in use.

### DETAILED DESCRIPTION

Each of OLED lighting apparatuses 16, 64, and 90 according to embodiments described below includes an OLED panel 20, an illuminance sensor 12 or a motion sensor 66 or 96, and a control device 14 or 68. The OLED panel 20 transmits light when the light is OFF and performs irradiation of light from one surface side of an irradiation surface 21 when the light is ON. The illuminance sensor 12 or the motion sensor 66 or 96 detects an environmental condition on the other surface side of the irradiation surface 21 of the OLED panel 20. The control device 14 or 68 controls a lighting state of the OLED panel 20 which is ON in response to the environmental condition detected by the illuminance sensor 12 or the motion sensor 66 or 96. The control device 14 or 68 also switches the lighting state of the OLED panel between ON and OFF.

In the OLED lighting apparatus 16 according to an embodiment described below, the illuminance sensor 12 detects brightness on the other surface side of the irradiation surface 21 of the OLED panel 20 as the environmental condition. The control device 14 controls the lighting state of the OLED panel 20 in response to the brightness detected by the illuminance sensor 12.

In the OLED lighting apparatus 16 according to the embodiment described below, the control device 14 enhances the luminous intensity of the OLED panel 20 as the brightness detected by the illuminance sensor 12 becomes brighter.

In the OLED lighting apparatus 16 according to the embodiment described below, the control device 14 controls the luminous intensity of the OLED panel 20 to be higher than the brightness detected by the illuminance sensor 12.

In the OLED lighting apparatus 64 or 90 according to an embodiment described below, the motion sensor 66 or 96 detects a person on the other surface side of the irradiation surface 21 of the OLED panel 20 as the environmental condition. The control device 68 switches the lighting state of the OLED panel 20 between ON and OFF in response to the person detected by the motion sensor 66 or 96.

In the OLED lighting apparatus 64 according to the embodiment described below, the OLED panel 20 can be individually ON for a plurality of regions. The motion sensor 66 detects a person on the other surface side of the irradiation surface 21 individually for the plurality of regions of the OLED panel 20. The control device 68 causes a region in which no person is detected by the motion sensor 66 to be OFF and causes a region in which a person is detected by the motion sensor 66 to be ON, out of the plurality of regions of the OLED panel 20.

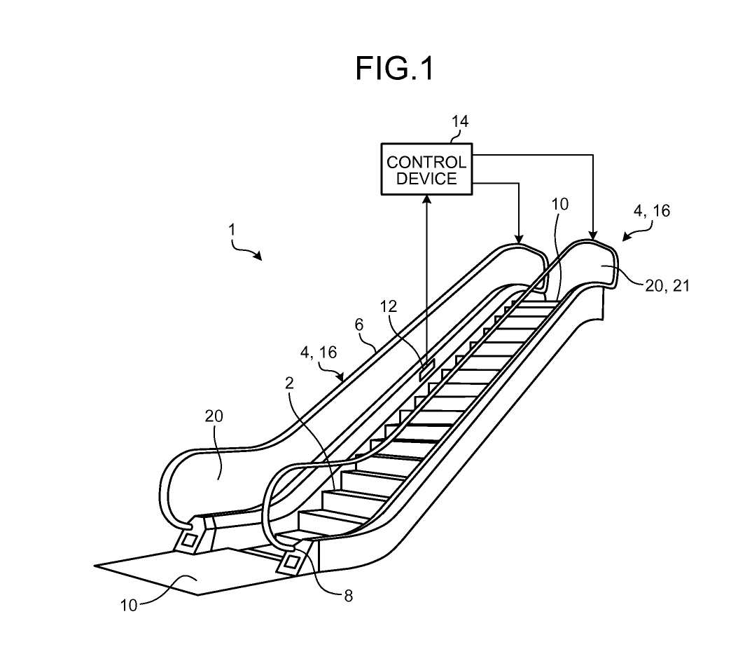

Subsequently, an OLED lighting apparatus of Embodiment 1 will be described with reference to the drawings. FIG. 1 is a schematic diagram of an escalator in which the OLED lighting apparatus of Embodiment 1 is used. An escalator 1 illustrated in FIG. 1 is configured to have a plurality of steps 2, a pair of banister panels 4, and handrail belts 6. Among thereof, the steps 2 allow a user who is the using subject of the escalator 1 to step onto and circularly move between platforms 10 which are positioned at both ends in a vertical direction, by a driving apparatus (not illustrated).

The banister panels 4 are installed on both the right and left sides of the steps 2 facing outward when a direction orthogonal to a movement direction of the steps 2 are referred to as a lateral direction so as to face each other interposing the plurality of steps 2 therebetween. The handrail belts 6 are provided to allow a user to rest one's hands thereon and are respectively wound around peripheral portions of the banister panels 4 to be movable. The handrail belts 6 are synchronized with movements of each of the steps 2 so as to move between belt gates 8 which are respectively positioned at both ends in the vertical direction, by the driving apparatus.

The OLED lighting apparatuses 16 of Embodiment 1 are used in the banister panels 4 of the escalator 1. In brief, the OLED lighting apparatuses 16 are formed to be plate-shaped partition members, and are arranged on both the right and left sides of the steps 2 in the escalator 1. The OLED lighting apparatuses 16 on the right and left face each other and are erected in a direction in which a thickness direction thereof is the lateral direction.

The OLED lighting apparatuses 16 are configured by using the OLED panels 20 in which an organic light-emitting diode (OLED) is adopted. Therefore, in other words, in the OLED lighting apparatuses 16, the OLED panels 20 are respectively positioned at positions on both the right and left sides of the steps 2, that is, are respectively positioned on both sides of a user on the steps 2 in the escalator 1, thereby being arranged in a direction facing each other.

The OLED panels 20 can perform irradiation of light by being ON. The OLED panels 20 are arranged in a direction to perform irradiation of light toward a side opposite to a side on which the other OLED panel 20 is positioned, between both the surfaces thereof in the thickness direction when the light is ON. That is, the OLED panels 20 are arranged to respectively cause the irradiation surfaces 21 which are the surfaces performing irradiation of light when the light is ON to face the outside of the escalator 1 in the lateral direction.

The illuminance sensor 12 which is an environment detector detecting brightness as the environmental condition is provided in the escalator 1. The illuminance sensor 12 can detect surrounding brightness by adopting a photodiode, for example. The illuminance sensor 12 is arranged between each of the OLED lighting apparatuses 16 on the right and left, and is installed in a portion which supports the OLED lighting apparatus 16. Accordingly, the illuminance sensor 12 can detect brightness of a portion between the OLED lighting apparatuses 16 on the right and left.

The control device 14 which is a controller switching the lighting state of the OLED panel 20 between ON and OFF is connected to the OLED panel 20 and the illuminance sensor 12. The OLED lighting apparatus 16 of Embodiment 1 is configured to include the OLED panel 20, the illuminance sensor 12 which is the environment detector, and the control device 14. The control device 14 can control the lighting state of the OLED panel 20 which is ON in response to the brightness detected by the illuminance sensor 12. Since the control device 14 has a known hardware configuration which includes a processing portion having a central processing unit (CPU), a memory portion such as a random access memory (RAM), and the like, a description thereof will not be repeated. The control device 14 having such a configuration is described to be exposed to the outside in FIG. 1, for convenience. However, the control device 14 is practically installed under the platform 10 together with a control device (not illustrated) which controls an operation of the escalator 1.

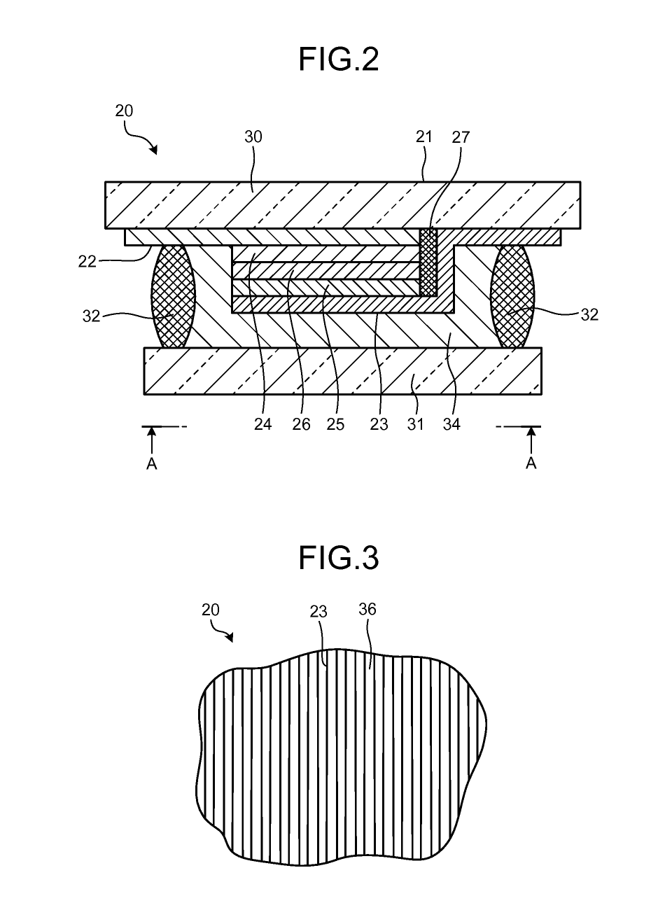

FIG. 2 is a detailed cross-sectional view of the OLED panel illustrated in FIG. 1. In the OLED panel 20, an anode 22 in which positive holes are conducted and a cathode 23 in which electrons are conducted are arranged on a glass substrate 30 which is a plate-shaped member made with a glass material that transmits light. In the OLED panel 20, a positive hole transport layer 24, an electron transport layer 25, and a light emission layer 26 are formed in layers at a portion emitting light. Among thereof, the positive hole transport layer 24 can transport positive holes conducted in the anode 22. The positive hole transport layer 24 is layered on a side of the anode 22 opposite to the glass substrate 30 side.

The electron transport layer 25 can transport electrons conducted in the cathode 23. The electron transport layer 25 is positioned on a side of the positive hole transport layer 24 opposite to the anode 22 side. The light emission layer 26 is positioned between the positive hole transport layer 24 and the electron transport layer 25 in a layer direction. A light emission material of the light emission layer 26 can emit light when positive holes transported by the positive hole transport layer 24 and electrons transported by the electron transport layer 25 are coupled in the light emission layer 26.

The cathode 23 is away from the glass substrate 30 at a portion where the positive hole transport layer 24, the light emission layer 26, and the electron transport layer 25 are layered. The cathode 23 is arranged on a surface of the electron transport layer 25 side opposite to the light emission layer 26 side. In detail, the cathode 23 is away from a portion layered on the glass substrate 30, and an insulation portion 27 interposes between the cathode 23 and the anode 22, the positive hole transport layer 24, the light emission layer 26, and the electron transport layer 25 in layers. Then, the cathode 23 is arranged across the surface of the electron transport layer 25 side opposite to the light emission layer 26 side. Accordingly, the cathode 23 can transfer electrons conducted in the cathode 23 to only the electron transport layer 25.

On a surface of the layered side of the glass substrate 30, that is, on a surface where the anode 22, the cathode 23, the positive hole transport layer 24, the light emission layer 26, and the electron transport layer 25 are arranged, in a state where the layers are arranged, a sealing glass 31 is arranged and is supported by a sealing member 32. In detail, for example, the sealing glass 31 is formed with a glass material similar to the glass substrate 30, that is, the sealing glass 31 is formed to have a plate shape using a material which transmits light.

Similarly, the sealing member 32 is also made with the material transmits light. The sealing glass 31 overlaps the surface of the side where the anode 22, the cathode 23, and the like are arranged on the glass substrate 30, causing the sealing member 32 to interpose therebetween. The sealing member 32 serves as a member to support the sealing glass 31 with respect to the glass substrate 30 side. On the glass substrate 30 where the anode 22, the cathode 23, and the like are arranged, the sealing glass 31 is arranged having the sealing member 32 to interpose therebetween in the above-described manner. Furthermore, the surface of the side where each of the members is arranged on the glass substrate 30 is sealed by filling a light-transmitting sealing agent 34 therebetween.

In the OLED panel 20 formed in such a manner, the glass substrate 30 side between the glass substrate 30 side and the sealing glass 31 side serves as the irradiation surface 21 which performs irradiation of light when the OLED panel 20 is ON. That is, in the OLED panel 20, a surface on a side of the glass substrate 30 opposite to the side where the anode 22 and the like are arranged serves as the irradiation surface 21. The OLED panels 20 are arranged on both sides of the steps 2 in the lateral direction, causing the irradiation surface 21 to face the outside of the escalator 1 in the lateral direction.

Among the members configuring the OLED panel 20, the anode 22 adopts an indium in oxide (ITO) electrode which is a transparent conductive film. The positive hole transport layer 24, the light emission layer 26, and the electron transport layer 25 also can transmit light by being formed with the materials which transmit light, and being thin films.

Meanwhile, the cathode 23 is formed with a high reflection member such as aluminum or silver having high electrical conductivity and reflecting light so as not to transmit therethrough.

FIG. 3 is a cross-sectional view taken along line III-III in FIG. 2. For example, the cathode 23 formed with the high reflection member is formed to have a micro wire in a predetermined wire pattern. When the OLED panel 20 is seen in the thickness direction, a space between a cathode 23 and another cathode 23 adjacent to each other forms a gap 36. Since the cathode 23 is formed with the member that does not transmit light while other members are formed to transmit light, when the OLED panel 20 is seen in the thickness direction, the position of the cathode 23 does not transmit light but the gap 36 between the cathode 23 and the adjacent cathode 23 can transmit light. Therefore, the OLED panel 20 transmits light when the light is OFF by allowing light to be transmitted through the gap 36 in such a manner. It is preferable to appropriately set a ratio of the cathode 23 and the gap 36 when the OLED panel 20 is seen in the thickness direction in accordance with desired transmittance.

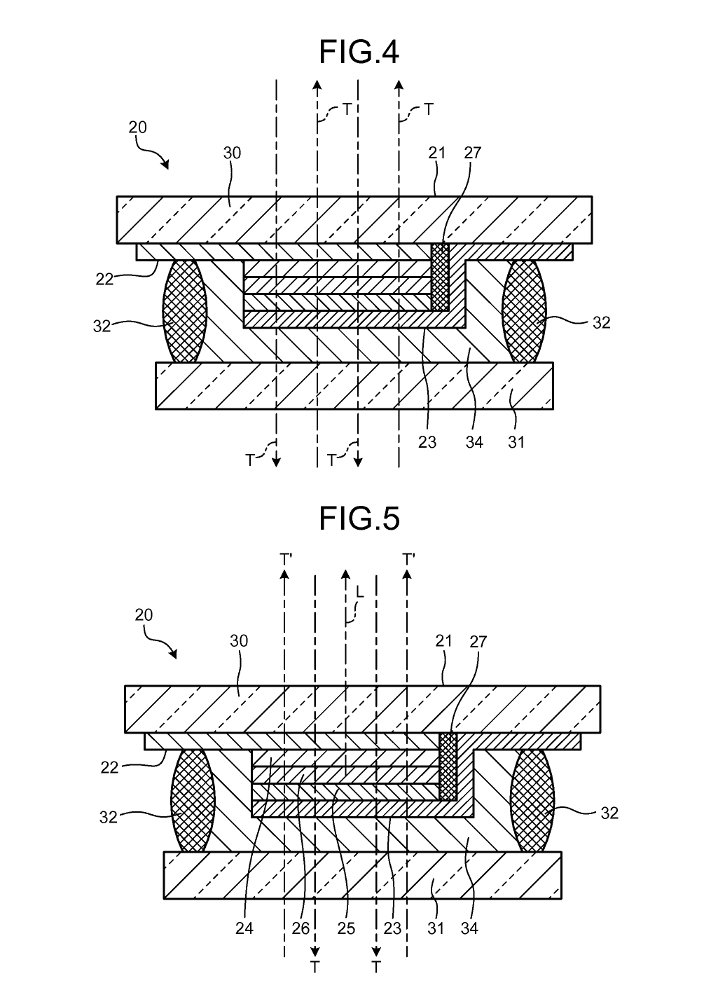

The OLED lighting apparatus 16 of Embodiment 1 is configured as described above. Hereinafter, operations thereof will be described. FIG. 4 is a diagram illustrating the OLED panel when the light is OFF. The lighting state of the OLED panel 20 provided on both the right and left sides of the steps 2 in the escalator 1 can be controlled by the control device 14. Initially, the lighting states of the OLED panel 20 when the light is ON and OFF will be described. When the OLED panel 20 is OFF, electricity is not applied to the OLED panel 20 so that positive holes and electrons are not supplied thereto, and thus, there is no light emission from the light emission layer 26. Since the OLED panel 20 does not perform irradiation of light in the above-described state, a person in the vicinity of the OLED panel 20 can visually recognize light transmitted through the portion of the OLED panel 20 which transmits light.

In brief, light incident on the OLED panel 20 in the thickness direction is blocked by only the cathode 23, but is transmitted through the portion of the gap 36. Therefore, a person on the glass substrate 30 side of the OLED panel 20 can visually recognize transmitted light T which is transmitted through the gap 36, is then transmitted through the electron transport layer 25, the light emission layer 26, the positive hole transport layer 24, and the anode 22, and is transmitted through the glass substrate 30, from the sealing glass 31 side toward the glass substrate 30 side. Similarly, a person on the sealing glass 31 side of the OLED panel 20 can visually recognize the transmitted light T which is transmitted through the gap 36, from the glass substrate 30 side toward the sealing glass 31 side.

FIG. 5 is a diagram illustrating the OLED panel when the light is ON. In regards to this, when the OLED panel 20 is ON, electricity is applied to the OLED panel 20. Accordingly, positive holes are conducted in the anode 22, and the conducted positive holes are transported by the positive hole transport layer 24 toward the light emission layer 26. Electrons are conducted in the cathode 23, and the conducted electrons are transported toward the light emission layer 26 by the electron transport layer 25. When the positive holes transported by the positive hole transport layer 24 and the electrons transported by the electron transport layer 25 are carried to the light emission layer 26, the positive holes and the electrons are coupled in the light emission layer 26. Accordingly, the light emission material of the light emission layer 26 emits light.

Among rays of light emitted from the light emission layer 26, the light toward the glass substrate 30 side is transmitted through the positive hole transport layer 24 and the anode 22 which is formed with a transparent electrode, and is further transmitted through the glass substrate 30, thereby being emitted from the irradiation surface 21 as irradiation light L.

Meanwhile, among rays of light emitted from the light emission layer 26, the light toward the sealing glass 31 side is transmitted through the electron transport layer 25, thereby arriving at the cathode 23. Since the cathode 23 is formed with the high reflection member reflecting light so as not to transmit therethrough, the light arrived at the cathode 23 reflects at the cathode 23. The light which reflects at the cathode 23 is oriented in a direction of the glass substrate 30, and is emitted from the irradiation surface 21 as the irradiation light L, similar to the light oriented toward the glass substrate 30 side from the light emission layer 26. When the OLED panel 20 is ON, the irradiation light L is emitted from the irradiation surface 21, and thus, irradiation of the light is performed in a direction of a side where the irradiation surface 21 is positioned.

When the OLED panel 20 is ON, light is transmitted through the gap 36, thereby being transmitted through the OLED panel 20. Therefore, light incident on the OLED panel 20 from the glass substrate 30 side becomes the transmitted light T which is transmitted through the OLED panel 20, thereby being transmitted to the sealing glass 31 side. Accordingly, even when the OLED panel 20 is ON, a person on the sealing glass 31 side can visually recognize the transmitted light T transmitted through the gap 36 from the glass substrate 30 side toward the sealing glass 31 side.

Meanwhile, the light incident on the OLED panel 20 from the sealing glass 31 side is transmitted to the glass substrate 30 side as transmitted light T′ which is transmitted through the OLED panel 20. However, the transmitted light T′ which is transmitted from the sealing glass 31 side to the glass substrate 30 side has quantity of light less than the irradiation light L emitted from the irradiation surface 21 when the OLED panel 20 is ON. Therefore, it is difficult for a person on the glass substrate 30 side to visually recognize the transmitted light T′ oriented from the sealing glass 31 side to the glass substrate 30 side. In brief, since the irradiation light L when the OLED panel 20 is ON has quantity of light larger than the transmitted light T′ which is transmitted from the sealing glass 31 side to the glass substrate 30 side, the transmitted light T′ is vanished due to the irradiation light L. Therefore, for a person on the glass substrate 30 side of the OLED panel 20, it is extremely difficult to visually recognize or it is not possible to visually recognize the transmitted light T′ which is transmitted from the sealing glass 31 side to the glass substrate 30 side.

In such a manner, when the OLED panel 20 is ON, although irradiation of the irradiation light L is performed from the glass substrate 30 side, that is, the irradiation surface 21 side, it is possible to visually recognize the transmitted light T which is transmitted from the glass substrate 30 side to the sealing glass 31 side. Since the visibility of the transmitted light T′ which is transmitted through the OLED panel 20 from the sealing glass 31 side to the glass substrate 30 side depends on a relative relationship with the quantity of light of the irradiation light L with which the OLED panel 20 performs irradiation, when the quantity of light of the irradiation light L is small, it is relatively easy to visually recognize the transmitted light T′, and it becomes more difficult to visually recognize the transmitted light T′ as the quantity of light of the irradiation light L becomes larger.

In the OLED panel 20 having such a configuration, the lighting state thereof is controlled by the control device 14 in response to the brightness detected by the illuminance sensor 12. Specifically, when the detected brightness is relatively dim, the quantity of light of the irradiation light L is reduced, and as the detected brightness becomes brighter, the lighting state is controlled so as to enhance the luminous intensity of the OLED panel 20, thereby being difficult to visually recognize the sealing glass 31 side from the glass substrate 30 side to which irradiation of the irradiation light L is performed, via the OLED panel 20 side. Particularly, it is preferable to configure to cause the quantity of light of the irradiation light L to be larger than the brightness detected by the illuminance sensor 12, thereby being difficult to be visually recognized.

Regardless of the lighting state thereof, the OLED panel 20 transmits light which is incident thereon from the glass substrate 30 side in the thickness direction as well as light which is incident thereon from the sealing glass 31 side in the thickness direction. Therefore, the OLED panel 20 adopted in the banister panels 4 transmits light which is transmitted from the outside of the escalator 1 in the lateral direction to the steps 2 side. Accordingly, a user of the escalator 1 utilizing the escalator 1 by stepping on the steps 2 can visually recognize a state outside the escalator 1 in the lateral direction on account of the transmitted light T which is transmitted through the OLED panel 20.

In a state where the quantity of light of the irradiation light L with which the OLED panel 20 performs irradiation is little, the quantity of light of the irradiation light L which is oriented from the OLED panel 20 to the outside of the escalator 1 in the lateral direction is reduced. Therefore, in this case, it is difficult that the transmitted light T oriented from the steps 2 side to the outside of the escalator 1 in the lateral direction is vanished due to the irradiation light L. However, since the quantity of light of the irradiation light L of the OLED panel 20 is reduced when a portion between the banister panels 4 is in a relatively dark state, the quantity of light itself of the transmitted light T which is oriented from the steps 2 side to the outside of the escalator 1 in the lateral direction is reduced. Therefore, it is difficult to visually recognize a state of the portion between the banister panels 4 from the outside of the escalator 1 in the lateral direction, thereby functioning as the partition member on account of light.

In contrast, when the brightness detected by the illuminance sensor 12 indicates that the portion between the banister panels 4 is in a relatively bright state since the escalator 1 is illuminated with a lighting device which is installed in the vicinity of the escalator 1, the control device 14 controls the lighting state so as to enhance the luminous intensity of the OLED panel 20 in order to suppress the steps 2 side from being seen from the outside of the escalator 1 in the lateral direction. Even though the quantity of light of the irradiation light L is large on account of the enhanced luminous intensity, the OLED panel 20 transmits light which is incident thereon from the glass substrate 30 side in the thickness direction. Therefore, the OLED panel 20 used in the banister panels 4 transmits light which is transmitted from the outside in the lateral direction to the steps 2 side. Accordingly, a user of the escalator 1 utilizing the escalator 1 by stepping on the steps 2 can visually recognize the state outside the escalator 1 in the lateral direction on account of the transmitted light T which is transmitted through the OLED panel 20.

Even though the quantity of light of the irradiation light L is large, the OLED panel 20 transmits light which is incident thereon from the sealing glass 31 side in the thickness direction. However, since the transmitted light T′ has the less quantity of light than the irradiation light L, it is difficult for a person outside the banister panels 4 of the escalator 1 in the lateral direction to visually recognize the transmitted light T′. Accordingly, the person outside the banister panels 4 of the escalator 1 in the lateral direction cannot recognize the state between the banister panels 4, and thus, a portion of the banister panels 4 overlapping the person on the steps 2 cannot be recognized.

The OLED panel 20 performs irradiation of the irradiation light L from the irradiation surface 21. However, since the OLED panel 20 is arranged to cause the irradiation surface 21 to be oriented to the outside of the escalator 1 in the lateral direction, the irradiation light L is oriented to both the outside directions of the escalator 1 in the lateral direction. Therefore, when the OLED panel 20 is ON, both the side directions of the escalator 1 in the lateral direction are illuminated with the irradiation light L, thereby causing the surroundings of the escalator 1 to be bright.

Since the above-described OLED lighting apparatus 16 of Embodiment 1 uses the OLED panel 20 which transmits light when the light is OFF and performs irradiation of light from the irradiation surface 21 side when the light is ON, the transmitted light T can be visually recognized from the other surface side of the irradiation surface 21 regardless of the lighting state, and thus, it is possible to ensure the aesthetic beauty of the landscape from the opposite surface side. Since the lighting state of the OLED panel 20 is controlled in response to the brightness detected by the illuminance sensor 12 as an environmental condition on the opposite surface side of the irradiation surface 21 in the OLED panel 20, it is possible to cause the opposite surface side to be difficult to be seen from the irradiation surface 21 side regardless of the brightness on the opposite surface side of the irradiation surface 21. As a result, it is possible to cause the OLED panel 20 to function as the partition member which is compatible with both ensuring the aesthetic beauty of the landscape and protecting the privacy. A passenger on the escalator 1 can take a look at the scenery outside while moving using the escalator 1, thereby making it possible to decrease an oppressive feeling.

Since the control device 14 controls the lighting state of the OLED panel 20 in response to the brightness detected by the illuminance sensor 12, regardless of the brightness on a surface side where the sealing glass 31 is positioned, quantity of light of the irradiation light L with which the irradiation surface 21 performs irradiation can be controlled to be quantity of light which can vanish the transmitted light T emitted from the irradiation surface 21. As a result, regardless of the brightness on the other surface side of the irradiation surface 21, it is possible to cause the opposite surface side to be difficult to be seen from the irradiation surface 21 side, thereby it is possible to more reliably ensure the protection of privacy while ensuring the aesthetic beauty of the landscape as well.

Since the control device 14 enhances the luminous intensity of the OLED panel 20 as the brightness detected by the illuminance sensor 12 becomes brighter, it is possible to suppress the quantity of light of the irradiation light L from being excessively larger than necessary. Thus, the irradiation surface 21 side can be caused to be difficult to be seen from the opposite surface side thereof with a minimum amount of power consumption necessary. As a result, it is possible to achieve both the ensuring of the aesthetic beauty of the landscape and protecting the privacy to be compatible while suppressing the amount of the power consumption.

Since the control device 14 controls the luminous intensity of the OLED panel 20 to be more enhanced than the brightness detected by the illuminance sensor 12, the irradiation surface 21 side can be caused almost not to be seen from the opposite surface side thereof.

The OLED lighting apparatus 64 of Embodiment 2 has substantially the same configuration as that of the OLED lighting apparatus 16 of Embodiment 1. However, the OLED lighting apparatus 64 is characterized in making notification of information. Other configurations are the same as that of Embodiment 1, and thus, the same reference numerals and signs will be applied thereto and the descriptions thereof will not be repeated.

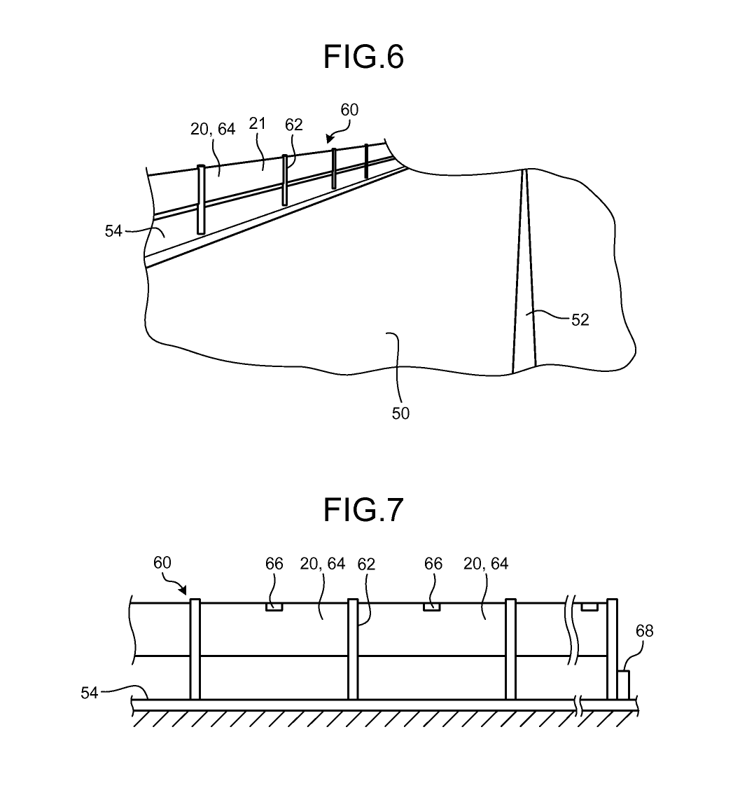

FIG. 6 is a diagram illustrating a guardrail in which the OLED lighting apparatus of Embodiment 2 is used. Being different from the OLED lighting apparatus 16 of Embodiment 1, the OLED lighting apparatus 64 of Embodiment 2 is used in a guardrail 60 which divides a roadway 50 and a sidewalk 54 on roads. In brief, the sidewalk 54 is positioned on a side opposite to the side where a centerline 52 is positioned, in a width direction of the roadway 50, that is, in the lateral direction of vehicles traveling the roadway 50. The guardrail 60 is erected in a border portion of the sidewalk 54 and the roadway 50 and provided along the roadway 50 and the sidewalk 54.

As the guardrail 60, a plurality of props 62 are erected along the roadway 50 and the sidewalk 54, and the OLED lighting apparatus 64 is formed to be bridged between the adjacent props 62. In detail, the OLED lighting apparatus 64 is formed to have a substantially rectangular plate shape in which the length in a longitudinal direction is approximately the same length as the distance between the adjacent props 62, and the length on a short side is shorter than the length of the props 62. The OLED lighting apparatus 64 formed to have such a plate shape is positioned between the adjacent props 62 so as to cause the thickness direction to be the width direction of the roadway 50 and the sidewalk 54. Both ends of the OLED lighting apparatus 64 in the longitudinal direction are respectively connected to the props 62. Accordingly, the guardrail 60 is formed along the roadway 50 and the sidewalk 54, dividing the roadway 50 and the sidewalk 54.

Similar to the OLED lighting apparatus 16 of Embodiment 1, the OLED lighting apparatus 64 is configured to use the OLED panel 20. The OLED panel 20, similar to the OLED panel 20 of the OLED lighting apparatus 16 of Embodiment 1 as well, is configured to be able to transmit light when the light is OFF and to perform irradiation of light from the irradiation surface 21 when the light is ON, and the irradiation surface 21 is arranged to be oriented facing the roadway 50 side.

FIG. 7 is a view illustrating the guardrail in FIG. 6 when seen from the sidewalk side. In the guardrail 60, the motion sensor 66 which is the environment detector detecting the environmental condition is arranged on the other surface side of the irradiation surface 21 of the OLED panel 20, that is, on the surface side of the sidewalk 54 side. The motion sensor 66 is provided for each OLED panel 20 arranged between the adjacent props 62. When a person walking on the sidewalk 54 approaches each motion sensor 66, each motion sensor 66 can detect the person. In brief, the OLED panel 20 is provided to have a plurality of regions by being arranged in a plurality of the OLED panels 20 along the roadway 50 and the sidewalk 54 so as to be able to be ON for each of the plurality of regions. The motion sensor 66 can detect a person on the other surface side of the irradiation surface 21 for each of the plurality of regions of the OLED panel 20.

The OLED panel 20 and the motion sensor 66 are electrically connected to the control device 68 which is the controller. The control device 68 can switch the lighting state of the OLED panel 20 between ON and OFF in response to a state of a person detected by the motion sensor 66. That is, the control device 68 can cause the region in which no person is detected by the motion sensor 66 to be OFF and can cause the region in which a person is detected by the motion sensor 66 to be ON, among the plurality of regions of the OLED panel 20. The OLED lighting apparatus 64 of Embodiment 2 is configured to include the OLED panel 20, the motion sensor 66 which is the environment detector, and the control device 68.

Regarding the control device 68, switching of the lighting state of a plurality of the OLED panels 20 between ON and OFF and acquiring the detection result of a person by the plurality of motion sensors 66 can be performed with one control device 68, thereby being included in predetermined props 62. Having such a combination as one set, a plurality of the OLED lighting apparatuses 64 are provided in an extension direction of the guardrail 60.

The OLED lighting apparatus 64 of Embodiment 2 is configured as described above. Hereinafter, operations thereof will be described. The OLED panel 20 included in the OLED lighting apparatus 64 of Embodiment 2 can be ON for each of the OLED panel 20 positioned between the props 62. In other words, the OLED panel 20 is defined that each OLED panel 20 between the props 62 is set as one region, and thus, the OLED lighting apparatus 64 includes the OLED panel 20 having the plurality of regions. The OLED panel 20 provided in such a manner can be ON for each of the plurality of regions.

The motion sensor 66 can detect a person on the other surface side of the irradiation surface 21 for each of the OLED panel 20 positioned between the props 62, that is, for each of the plurality of regions of the OLED panel 20. The control device 68 switches the lighting state of the OLED panel 20 between ON and OFF in response to the detection result by the motion sensor 66. Specifically, the control device 68 causes the OLED panel 20 to be in OFF state during normal time. Therefore, each OLED panel 20 between the props 62 can transmit both the light which oriented from the roadway 50 side to the sidewalk 54 side and the light which is oriented from the sidewalk 54 side to the roadway 50 side.

Particularly, since the quantity of light of the sun irradiating the roadway 50 and the sidewalk 54 is large when it is sunny during the daytime, the quantity of light reflected on the roadway 50 and the sidewalk 54 during the daytime is also large, and thus, the OLED panel 20 can transmit large quantity of the reflected light. Accordingly, the state on the sidewalk 54 side can be recognized from the roadway 50 side and the state on the roadway 50 side can be recognized from the sidewalk 54 side, by visually recognizing the transmitted light.

Particularly, during the nighttime, when a person walking on the sidewalk 54 is detected by a certain motion sensor 66, the control device 68 causes the OLED panel 20 in the region where the motion sensor 66 is installed to be ON. Since the OLED panel 20 is arranged so as to cause the irradiation surface 21 to face the roadway 50 side, when the OLED panel 20 is ON, irradiation of the irradiation light L is performed toward the roadway 50. That is, in the irradiation surface 21 of the OLED panel 20, the irradiation surface 21 corresponding to the portion where a person is present on the sidewalk 54 is ON.

When a person on the sidewalk 54 side is walking on the sidewalk 54, causing the motion sensor 66 which is detecting the person by that time is no longer able to detect the person, the control device 68 causes the OLED panel 20 in the region where the motion sensor 66 is installed to be OFF. Then, when the person walking on the sidewalk 54 is detected by another motion sensor 66 not the motion sensor 66 which is detecting the person by that time, the OLED panel 20 in the region where the motion sensor 66 is installed is ON. Accordingly, the irradiation surfaces 21 facing the roadway 50 side vary in the portion to be ON in response to the person walking on the sidewalk 54. In the irradiation surfaces 21, the portion to be ON moves along a person walking on the sidewalk 54.

Therefore, the driver of a vehicle traveling the roadway 50 can recognize a position of a person walking on the sidewalk 54 by visually recognizing the irradiation light L from the irradiation surfaces 21 of which the portion to be ON move. In brief, since there is no sunlight irradiating the roadway 50 and the sidewalk 54 during the nighttime, and the irradiated quantity of sunlight is small during the bad weather as well, the light is reflected on the roadway 50 and the sidewalk 54, and thus, the quantity of light transmitted through the OLED panel 20 also becomes small. Therefore, although it is difficult to recognize the state of the sidewalk 54 from a vehicle on the roadway 50, despite of such a case, it is possible to recognize a pedestrian on the sidewalk 54 by recognizing the irradiation light L with which the OLED panel 20 performs irradiation. Accordingly, the driver of a vehicle traveling the roadway 50 can drive the vehicle while paying attention to the pedestrian.

In the OLED lighting apparatus 64 of Embodiment 2, the control device 68 switches the lighting state of the OLED panel 20 between ON and OFF in accordance with a person detected by the motion sensor 66, the environmental condition on the sidewalk 54 side can be transferred to the roadway 50 side using the irradiation light L from the OLED panel 20. As a result, the OLED lighting apparatus 64 can function as a unit to notify the driver of the presence of a person on the sidewalk 54.

The control device 68 can cause the region in which no person is detected by the motion sensor 66 to be OFF and can cause the region in which a person is detected by the motion sensor 66 to be ON, among the plurality of regions of the OLED panel 20, and thus, it is possible to cause the OLED panel 20 corresponding to the portion where a pedestrian is present to be ON in accordance with the person walking on the sidewalk 54. Accordingly, the state of a person walking on the sidewalk 54 can be more precisely transferred to the roadway 50 side. As a result, the notification regarding a person present on the sidewalk 54 can be more appropriately performed.

The OLED lighting apparatus 90 of Embodiment 3 has substantially the same configuration as that of the OLED lighting apparatus 16 of Embodiment 1. However, the OLED lighting apparatus 90 is characterized in being used in a table. Other configurations are the same as that of Embodiment 1, and thus, the same reference numerals and signs will be applied thereto and the descriptions thereof will not be repeated.

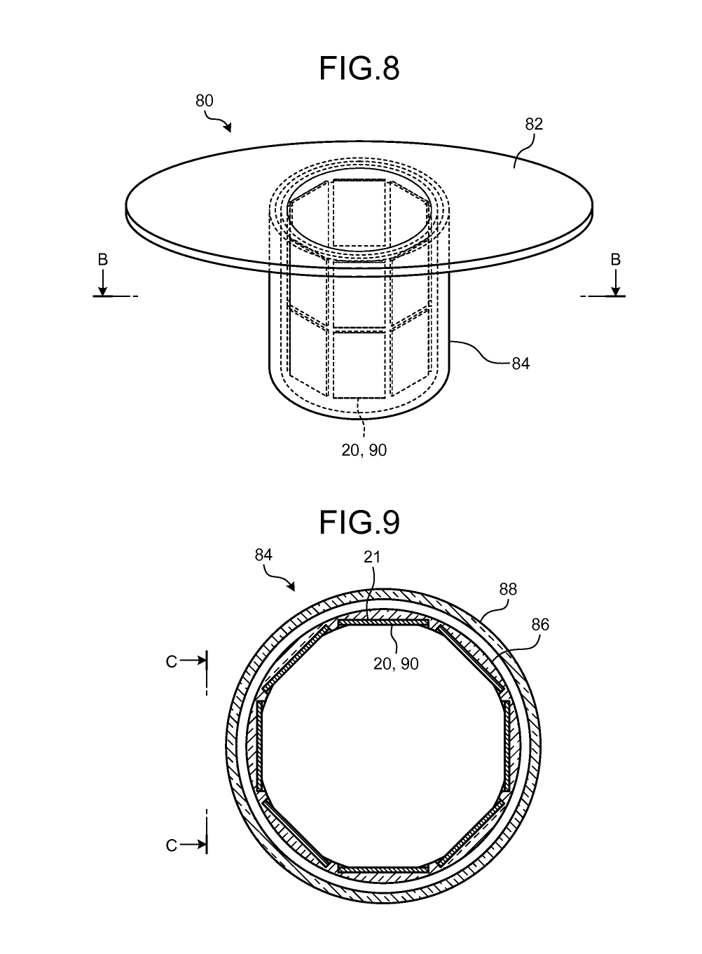

FIG. 8 is a perspective view of the table in which the OLED lighting apparatus of Embodiment 3 is used. Being different from the OLED lighting apparatus 16 of Embodiment 1, the OLED lighting apparatus 90 of Embodiment 3 is used in a table 80 on which foods and the like are placed. In the table 80, a table top 82 in which foods and the like are placed on the top surface thereof is formed with a transparent member such as glass, and a leg portion 84 which extends downward from the table top 82 to support the table top 82 is provided on a lower surface side of the table top 82. The leg portion 84 is formed to have a substantially cylindrical shape and is provided to be oriented causing an axial direction of a cylinder to be the vertical direction. In brief, the table top 82 is attached to an upper end of the substantially cylindrical-shaped leg portion 84, and a lower end side of the leg portion 84 is an installation portion of table 80 with respect to the floor surface.

Regarding the OLED panel 20 configuring the OLED lighting apparatus 90, there are provided the plurality of OLED panels 20 formed to have the substantially rectangular plate shape in the leg portion 84. Specifically, the thickness direction of the OLED panel 20 is in the same direction as the thickness direction of a wall surface of the substantially cylindrical-shaped leg portion 84, and longitudinal direction in the rectangle shape is arranged to be oriented in the axial direction, that is, the vertical direction of the leg portion 84. Two OLED panels 20 arranged to be oriented in such a manner are provided together in the vertical direction as a set, and thus, a plurality of sets are provided side-by-side in a peripheral direction of the leg portion 84.

The motion sensor 96 (refer to FIG. 11) which is the environment detector is arranged on the side surface of the leg portion 84 of the table 80. The lighting state of the OLED panel 20 is switched between ON and OFF in response to the detection result of the motion sensor 96. The OLED lighting apparatus 90 of Embodiment 3 is configured to include the OLED panel 20, the motion sensor 96, and the control device (not illustrated) which is similar to that of Embodiments 1 and 2.

FIG. 9 is a cross-sectional view taken along line IX-IX in FIG. 8. The leg portion 84 is formed with a substantially cylindrical-shaped support case 86 and a substantially cylindrical-shaped protection case 88 of which an inner diameter is larger than an outer diameter of the support case 86. The support case 86 is in a state of being inserted into the protection case 88 to be integrally configured therewith. Both the support case 86 and the protection case 88 are formed with the transparent member similar to the table top 82. The OLED panel 20 is supported by the support case 86 thereamong.

A position where the OLED panel 20 is arranged on an inner surface of the support case 86 is cut in the thickness direction of the wall portion of the support case 86 in a shape equivalent to the shape of the OLED panel 20 in a planar view, and the OLED panel 20 is caused to fit the cut portion. The support case 86 supports the plurality of OLED panels 20 in this manner. In this case, the OLED panel 20 is arranged causing the irradiation surface 21 side to face an outer side of the support case 86 in a radial direction. In brief, the plurality of OLED panels 20 are arranged outward in the radial direction of the leg portion 84. The protection case 88 is arranged to cover the support case 86, as a member protecting the OLED panel 20 which is supported by the support case 86 in such a manner.

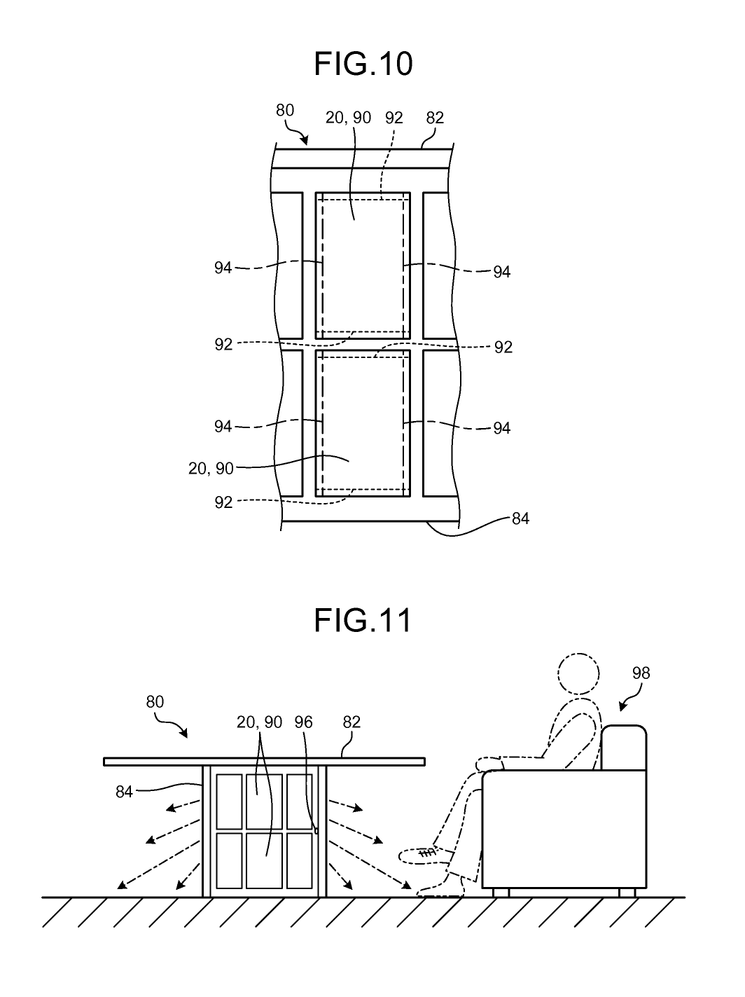

FIG. 10 is an arrow view of line X-X in FIG. 9. There is provided a wire to supply electricity to the OLED panel 20 by covering micro wires by the transparent coating. That is, both a positive wire 92 which is a wire on the positive side for supplying electricity to the anode 22 of the OLED panel 20, and a negative wire 94 which is a wire on the negative side for supplying electricity to the cathode 23 thereof are formed with micro wires and are covered by the transparent coating. In each of the OLED panels 20, two of both the positive wires 92 and the negative wires 94 are arranged. In brief, since the OLED panel 20 has a large light-emitting area, when electricity is supplied through only one set of the positive wire 92 and the negative wire 94 with respect to the OLED panel 20, there may be an occurrence of brightness unevenness due to a difference in flowing current amounts, depending on a place of the inner surface of the OLED panel 20. Therefore, in the OLED lighting apparatus 90 of Embodiment 3, in order to suppress the brightness unevenness, two of both the positive wires 92 and the negative wires 94 are arranged in one OLED panel 20.

For example, two of the positive wires 92 are individually arranged in the vicinity of two sides of the rectangular OLED panel 20 on the short sides, along the sides thereof. Two of the negative wires 94 are individually arranged in the vicinity of two sides of the rectangular OLED panel 20 in the longitudinal direction along the sides thereof. In this manner, two sets of the positive wires 92 and the negative wires 94 are arranged in one OLED panel 20, and electricity is supplied through the two sets of the positive wires 92 and the negative wires 94, and thus, electricity can be supplied in a nearly uniform state with respect to each portion of the OLED panel 20 having a large light-emitting area. Accordingly, the OLED panel 20 can be uniformly ON without having the occurrence of the brightness unevenness throughout the irradiation surface 21 when the light is ON.

The OLED lighting apparatus 90 of Embodiment 3 is configured as described above. Hereinafter, operations thereof will be described. FIG. 11 is a view illustrating an aspect of the table in FIG. 8 in use. The table 80 including the OLED lighting apparatus 90 of Embodiment 3 is used at a restaurant, for example. In this case, the table 80 is installed causing the motion sensor 96 of the leg portion 84 to be oriented facing a chair 98 which is used together with the table 80. Similar to the OLED lighting apparatus 64 of Embodiment 2, the OLED panel 20 is OFF when no person is detected by the motion sensor 96 and is ON when a person is detected by the motion sensor 96.

A description will be given regarding a case where no person is detected by the motion sensor 96. Since the motion sensor 96 faces the chair 98, the motion sensor 96 does not detect a person when no one sits on the chair 98, and thus, the OLED panel 20 is OFF. When the light is OFF, the OLED panel 20 transmits light in any direction of the thickness direction. Since both the support case 86 and the protection case 88 configuring the leg portion 84 are configured with the transparent members, the leg portion 84 transmits light when the OLED panel 20 is OFF. Therefore, a person on a side of the table 80 opposite to a side where the chair 98 is positioned can check the state on the chair 98 side by visually recognizing light transmitted through the leg portion 84. For example, even when there is an object at the feet of the chair 98, it is possible to check such an object.

When a person takes a seat on the chair 98 and the motion sensor 96 detects the person, the OLED panel 20 is ON. Since the OLED panel 20 is arranged to cause the irradiation surface 21 to be oriented facing the outer side of the leg portion 84 in the radial direction, when the OLED panel 20 is ON, the OLED panel 20 performs irradiation of the irradiation light L outward to the leg portion 84 in the radial direction. Accordingly, the surroundings of the table 80 on the lower side are illuminated. Thus, the aesthetic beauty of the landscape around the table 80 is improved, and a person at a position away from the table 80 can recognize that another person is sitting on the chair 98 adjacent to the table 80, through the light thereof.

The OLED panel 20 performs irradiation of the irradiation light L outward to the leg portion 84 in the radial direction, and thus, it is not possible to visually recognize the lower side of the chair 98 from the side of the table 80 opposite to a side where the chair 98 is positioned. That is, it is not possible to visually recognize the vicinity of the feet of a person sitting on the chair 98.

In this case, the OLED panel 20 irradiating light which vanishes light transmitted from the chair 98 side becomes the OLED panel 20 positioned on the side opposite to a side where the chair 98 is positioned, among the plurality of OLED panels 20. When seen from the OLED panel 20 which can cause the chair 98 side not to be visually recognized by lighting the OLED panel 20, the motion sensor 96 can detect the environmental condition on the other surface side of the irradiation surface 21 in the OLED panel 20. The table 80 including the OLED lighting apparatus 90 of Embodiment 3 also includes the OLED panel 20 having the irradiation surface 21 on the side where the motion sensor 96 detects a person, in addition to the OLED panel 20 which can cause the environmental condition on the other surface side of the irradiation surface 21 not to be visually recognized by being ON in such a manner.

Even when the OLED panel 20 is ON, the transmitted light T which is transmitted from the irradiation surface 21 side to the sealing glass 31 side can be visually recognized. The table top 82 is also formed with the transparent member that transmits light. Therefore, a person sitting on the chair 98 can check the state on the outside of the leg portion 84 in the radial direction from obliquely above the table 80 via the inner surface side of the substantially cylindrical leg portion 84. In brief, a person sitting on the chair 98 can check the state on the side opposite to a side where the chair 98 is positioned in the surroundings of the leg portion 84 by visually recognizing light which is incident on the leg portion 84 from outside the leg portion 84 in the radial direction, is transmitted through the protection case 88, the support case 86, and the OLED panel 20, and then is transmitted through the table top 82.

In the OLED lighting apparatus 90 of Embodiment 3, when the OLED panel 20 is ON, the vicinity of the feet of a person sitting on the chair 98 cannot be visually recognized from the side of the table 80 opposite to a side where the chair 98 is positioned, thereby making it possible to protect the privacy. In this case as well, a person sitting on the chair 98 can check the state on the outside of the leg portion 84 in the radial direction via the inner surface side of the leg portion 84, thereby making it possible to ensure the aesthetic beauty of the landscape. Furthermore, since other OLED panels 20 are included in addition to the OLED panel 20 which can cause the environmental condition on the other surface side of the irradiation surface 21 not to be visually recognized by being ON, it is possible to illuminate the surroundings of the OLED panel 20 when the light is ON, and to improve the aesthetic beauty of the appearance of the table. As a result, both ensuring the aesthetic beauty of the landscape and protecting the privacy can be compatible. Furthermore, it is possible to cause the OLED lighting apparatus to function as a lighting apparatus that can improve the aesthetic beauty of the appearance of the table.

In the OLED panel 20, two sets of the positive wires 92 and the negative wires 94 are included in one OLED panel 20, and electricity is supplied to the OLED panel 20 using two sets of the positive wires 92 and the negative wires 94, and thus, it is possible to uniformly supply electricity throughout the OLED panel 20. As a result, the brightness unevenness when the light is ON can be decreased, thereby making it possible to further improve the aesthetic beauty of the appearance of the table.

The OLED lighting apparatus 16 of Embodiment 1 is used as the partition member in the escalator 1. The OLED lighting apparatus 64 of Embodiment 2 is used in a notification light-emitting apparatus in the guardrail 60. The OLED lighting apparatus 90 of Embodiment 3 is used in the lighting device as the table 80. However, each of the OLED lighting apparatuses may be used for other purposes thereof. For example, the OLED lighting apparatus 16 of Embodiment 1 may be used in a window of a room so as to cause the inside of the room not to be visually recognized from the outside of the room when the OLED panel 20 is ON. In this case, the illuminance sensor 12 may be integrally formed with the OLED panel 20, or may be formed separately from the OLED panel 20 so as to be able to detect the brightness of the inside of a room. Otherwise, it may be used to provide a private space of a seat in a vehicle.

The OLED lighting apparatus 64 of Embodiment 2 may be used in the banister panels 4 of the escalator 1 so as to sequentially switch the lighting state of the OLED panel 20 between ON and OFF in response with movements of a person stepping on the escalator 1. The OLED lighting apparatus 64 of Embodiment 2 may be used as a partition of an admission waiting portion for attractions of entertainment facilities in an amusement park and the like so as to cause the OLED panel 20 to be ON in response with people waiting the admission. Accordingly, it is possible to grasp the approximate number of people waiting the admission from a distance, and it is possible to improve the aesthetic beauty of the appearance of the entertainment facilities by lighting the OLED panel 20.

In the OLED lighting apparatus 64 of Embodiment 2, one OLED panel 20 is set as one region, and the lighting state is switched between ON and OFF for each OLED panel 20. However, the region of which lighting state is switched between ON and OFF may be set other than as each OLED panel 20. For example, a plurality of regions in which the lighting states thereof can be individually switched between ON and OFF may be defined in one OLED panel 20 so as to switch the lighting state between ON and OF for each OLED panel 20. Accordingly, the lighting state of the OLED panel 20 is switched between ON and OFF along a person walking on the sidewalk 54 so that the lighting state can be more delicately switched between ON and OFF when notifying the driver of the presence of a person, thereby making it possible to perform precise notification.

In the OLED lighting apparatus 64 of Embodiment 2, when a person on the sidewalk 54 is detected, the OLED panel 20 corresponding to the portion is ON. However, when it is bright as in the daytime, the lighting state of the OLED panel 20 may be OFF regardless of the presence of a person. Since the OLED panel 20 can transmit light in both directions when the light is OFF, the driver in a vehicle traveling the roadway 50 can recognize a person walking on the sidewalk 54 through light which is transmitted through the OLED panel 20 under a bright environment. In this manner, the lighting state of the OLED panel 20 is OFF at all times in a bright state, and thus, the amount of electrical consumption can be reduced.

The OLED lighting apparatus 16 of Embodiment 1 may be installed so as to cause appreciation subjects to be positioned on the irradiation surface 21 side of the OLED panel 20. For example, animals in a zoo or works of art in an art gallery may be arranged on the irradiation surface 21 side of the OLED panel 20 so that appreciators can appreciate the subjects from the opposite side of the irradiation surface 21, that is, from the side where the sealing glass 31 is positioned. Accordingly, when the OLED panel 20 is ON, the appreciation subjects can be illuminated with the irradiation light L with which the irradiation surface 21 performs irradiation, and thus, the appreciators can appreciate the subjects by visually recognizing the appreciation subjects which are illuminated with the irradiation light L on account of the transmitted light T which is transmitted from the irradiation surface 21 side to the sealing glass 31 side. Accordingly, lighting equipment which illuminates the appreciation subjects can be simplified.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An OLED lighting apparatus comprising:
an OLED panel configured to transmit light when the light is OFF and perform irradiation of light from one surface side of an irradiation surface when lit;
an environment detector configured to detect an environmental condition on the other surface side of the irradiation surface of the OLED panel; and
a controller configured to control a lighting state of the OLED panel which is ON in response to the environmental condition detected by the environment detector or switch the lighting state of the OLED panel between ON and OFF.

2. The apparatus according to claim 1,
wherein the environment detector detects brightness on the other surface side of the irradiation surface of the OLED panel as the environmental condition, and
wherein the controller controls the lighting state of the OLED panel in response to the brightness detected by the environment detector.

3. The apparatus according to claim 2,
wherein the controller enhances luminous intensity of the OLED panel as the brightness detected by the environment detector becomes brighter.

4. The apparatus according to claim 3,
wherein the controller controls the luminous intensity of the OLED panel to be higher than the brightness detected by the environment detector.

5. The apparatus according to claim 1,
wherein the environment detector detects a person on the other surface side of the irradiation surface of the OLED panel as the environmental condition, and
wherein the controller switches the lighting state of the OLED panel between ON and OFF in response to the person detected by the environment detector.

6. The apparatus according to claim 5,
wherein the OLED panel can be individually ON for a plurality of regions,
wherein the environment detector detects a person on the other surface side of the irradiation surface individually for the plurality of regions of the OLED panel, and
wherein the controller causes a region in which no person is detected by the environment detector to be OFF and causes a region in which a person is detected by the environment detector to be ON, out of the plurality of regions of the OLED panel.
